(19) United States
(12) Patent Application Publication
(10) Pub. No.: US 2006/0085830 A1
(43) Pub. Date: Apr. 20, 2006

(54) Method and apparatus for content provisioning in a video on demand system

(76) Inventors: Timo Bruck, Mountain View, CA (US); Thomas R. Hammer, San Mateo, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/966,402

(22) Filed: Oct. 14, 2004

(51) Int. Cl. H04N 7/173; G06F 17/00; G06F 3/00; G06F 9/00

(52) U.S. Cl. 725/105; 725/109; 725/110; 715/733; 715/751

(57) ABSTRACT

Information regarding new programs available for viewing within a video-on-demand (VOD) service is added to a program guide used by subscribers for downloading and viewing such programs through a user interface configured for use by content providers. In one embodiment, the content itself and metadata describing it are passed to the VOD service; while in other embodiments, only the location of the content is provided with the metadata. The content and metadata may be reviewed at the discretion of the service provider before it appears in the program guide.

### BACKGROUND OF THE INVENTION

1. Field of the Invention

The invention relates generally to the field of video on demand (VOD). In one exemplary aspect, the invention relates to a computer-based tool (accessible, for example, via the World Wide Web or other user interface) made available to a content provider or distributor to publish to a content guide, assign viewing privileges, provide other metadata related to the content and optionally request transfer of the content to a VOD service provider.

2. Description of Related Technology

There is a pent up demand for niche entertainment and educational video content such as ethnic programming, video tutorials, corporate video material, etc. The Internet and related technologies have provided a technical solution for deployment of such services. For example, audio/video streaming and file sharing technologies are well known in the art and can be employed for the purpose of transferring content over the Internet from content providers to content users.

While such technology provides the technical feasibility to distribute Internet content, the task of searching for and downloading such content from the myriad of content providers that exist today remains a cumbersome process and, indeed, one that begins to become unmanageable as the number of websites of interest to a user grows. Even when the download process is partially automated (e.g., using techniques such as bookmarks and auto-updates), content searches still must be performed manually. Because of these and other complications, even if users find content of interest, it remains difficult to make purchasing decisions without further information such as a program guide, reviews, content advisory ratings, charges and credibility of the content provider. At least some of the present inventors have thus recognized that means for allowing users to view available content of interest from multiple content providers (as well as some or all of the above-described metadata) is desirable and have created a program guide for Internet content that serves such a purpose. This guide is described more fully in U.S. patent application Ser. No. ______, entitled “XXX”, filed on even date herewith and incorporated herein by reference. Accommodating the ever increasing library of available content to be listed in such a guide, however, requires additional means for publishing thereto. Such a mechanism is the subject of the present invention.

### SUMMARY OF THE INVENTION

The present invention addresses the foregoing needs by providing, in various embodiments, a method and apparatus for content providers to contribute either guide information for content or both content and guide information to a VOD service.

In a first aspect of the invention, a user interface having one or more Web forms configured to permit uploading of metadata describing multimedia content to a program guide distributable to remote set-top appliances configured to permit downloading of the multimedia content from Internet hosts other than that at which the program guide is available is disclosed. One embodiment of the user interface includes a provider portion and an reviewer portion, the provider portion configured to permit a provider of the multimedia content to enter a description the multimedia content according to a plurality of categories, and the reviewer portion configured to permit a human reader to review and accept or reject the description provided by the provider. In another embodiment, the reviewer portion further includes facilities for the human reviewer to review the multimedia content in addition to the description provided by the provider.

In a second aspect of the invention, a method for distributing metadata describing multimedia content available for download via the Internet to set-top appliances as a program guide which is composed of entries created by multimedia content providers using a Web form configured to accept information concerning the content and formatted according to a common schema for such metadata is disclosed. In various embodiments, prior to distributing the metadata at least some of the entries created by the multimedia content providers are reviewed using a read-only user interface. The program guide may include information regarding the cost to download the multimedia content described therein. In yet another embodiment of the present invention, the metadata is distributed via an Internet host different than one or more Internet hosts at which the multimedia content is hosted.

### BRIEF DESCRIPTION OF THE DRAWINGS

The above and other features and advantages of the present invention are hereinafter described in the following detailed description of illustrative embodiments to be read in conjunction with the accompanying drawings and figures, wherein like reference numerals are used to identify the same or similar system parts and/or method steps, and in which:

FIG. 1 illustrates a process performed, according to an embodiment of the present invention, by a human reviewer while reviewing programs sent by content providers to the VOD service.

FIG. 2 illustrates an example of a user interface in the form of a web page that is used, according to an embodiment of the present invention, for adding a program and related guide information to the VOD service guide database.

FIG. 3 shows further examples of web pages used to allow a content provider to submit information related to viewing rights and distribution preferences for a program to a content reviewer.

### DETAILED DESCRIPTION

Reference is now made to the drawings wherein like numerals refer to like parts throughout. Described herein are methods and apparatus for provisioning multimedia content in a VOD service. The present invention overcomes the limitations of conventional systems, in part by providing a web interface having two functional areas—one configured for a content provider to submit information regarding his/her multimedia content to VOD service provider to be included in the service provider's program guide, and the other configured for a reviewer to review such submissions and approve, modify and approve or reject same.

As used herein, the term “VOD” is meant to include on-demand delivery of audio, video, graphical icons, software, computer games, etc.

As used herein, the term “content” refers to audio, video, graphics files (in uncompressed or compressed format), icons, software, text files and scripts, data, binary files and other computer-usable data used to operate a client device and produce desired audio-visual effects on a client device for the viewer.

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the present invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

Content Provider

As used herein, the term “Content Provider” refers to a person or business entity that wants to make multimedia content available to the users of a VOD service. No particular assumptions about a business relationship between the content provider and the VOD Service Provider are critical to the present invention. Content providers may, in some instances, be large commercial enterprises such as movie studios, television broadcasters and the like. In other cases, the content providers may be individuals, small businesses, independent movie producers and so on. Thus, the term content provider is used generally to describe any person or entity that wishes to make content (and particularly audio-video content) available to others. Often, though not necessarily, the content will be made available for a fee.

VOD Service Provider

The commercial entity that provides an end user a VOD service including the ability to browse through available program titles, download content of interest and view it is called a VOD service provider herein. As was the case for the content provider, the VOD service provider can be any form of entity or an individual. In general, the VOD service provider need not be a network facilitator. For example, where the Internet is used as the distribution channel for the content, the VOD service provider need not be an Internet service provider, network operator or associated with any form of network infrastructure provision. Instead, the VOD service provider may operate one or more Internet hosts configured to provide the program guide described below and to facilitate the distribution of metadata regarding content available for download to end users thereof. Often, though not necessarily, the VOD service provider will operate Internet hosts from which the content is available for download, however, this is not critical to the present invention. The VOD service may make use of special or general purpose computer systems configured to download and display the Internet content using any of a variety of communication and presentation applications. The precise nature of such application programs and, indeed, the nature of the computer systems on which the content is played back is not critical to the present inventions except insofar as the discussion below indicates.

Outline of the Review Process

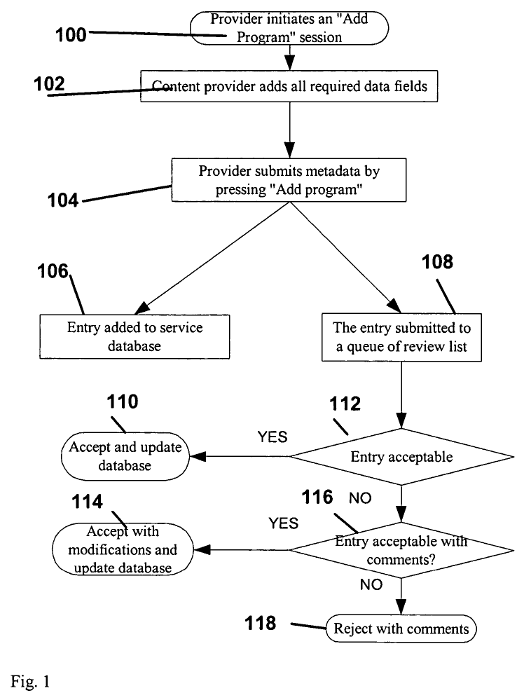

FIG. 1 outlines a process used by content providers and VOD service provider reviewers to add a program listing to the program guide managed by the VOD service provider. In some cases, the reviewers may be employees of the VOD service provider but this is not critical to the present invention. Often, the reviewers may by under contract to provide the review service to the VOD service provider, but not necessarily be employees thereof. In some cases, the reviewers may be associated with the content providers, for example where a content provider has contracted with the VOD service provider to perform in-house review of the content and its descriptions to be published to the program guide. Such a relationship may be advantageous insofar as it relieves the burden from having to perform the review from the VOD service provider while ensuring that the content provider's information receives uniform treatment across all content selections to be listed in the program guide. Other relationships between content providers, the VOD service provider and the reviewer(s) are also possible.

In step 100, a content provider initiates a web-based session (e.g., a secure sockets layer session) to add a new program listing to the guide (i.e., the content provider seeks to upload certain metadata regarding the content selection to a database maintained by the VOD service provider). Once such a session is established, in the next step (102), the content provider adds data to both mandatory and optional entry fields on the web page. Note that the Web page is merely one form of user interface that may be used to provide this means for the content provider to enter the metadata regarding the content selection. In other embodiments, database clients may be used to perform this task. Web pages are particularly advantageous, however, in that they are (for the most part) platform agnostic, allowing the content providers to choose their platform of choice for entering the information. The Web page or other user interface thus facilitates a data entry means for the content provider to inform the VOD service provider of the new content selection and to provide the VOD service provider with the content provider's desired characterization of that content, for inclusion in the program guide.

Once the content provider is satisfied with the accuracy of all the metadata, the VOD service provider is notified of availability of the content selection and the newly entered guide information (104). The notification may be an automated one wherein the VOD service logs this entry in a queue of all programs submitted for review (108) and also adds the program entry (i.e., the content selection) to a database that tracks program requests from various content providers (106). Thereafter, the metadata (and in some cases the content itself) is subject to review prior to publication in the guide.

In the review phase, the proposed entry might first be evaluated for acceptance (112) and found to be acceptable “as is” based on criteria such as the content provider's past submissions, business arrangements with the service provider and so on. If this is true, in step 110, the program entry is accepted and added to the database from which the program guide is generated. That is, the new entry is made viewable to subscribers of the VOD service, and the associated content can now be located (through the guide) for downloading and viewing.

Alternatively, during the review process the reviewer might find the submission to be acceptable with some minor modifications to the guide data or other attributes of the program (116). In that case, the program will be added to the database of available programs with revisions (114). In some cases, the reviewer may make the necessary revisions or may have them done by another individual associated with the VOD service. If the required revisions cannot be implemented by the reviewer or other member of the VOD service, however, it may be necessary to have the content provider resubmit the entry with the revisions. Otherwise, if the entry is unacceptable and cannot be revised, the program will be rejected (possibly with comments concerning the reason for rejection) (118) and the content provider notified of this decision.

As indicated above, a preferred means of providing access for content providers to provide submissions and reviewers to review same is a web-based user interface. Thus, below are described a number of web forms that may be made available for such purposes. Where illustrated, the user interfaces presented herein should be regarding as examples thereof and not read so as to limit the scope of the present invention. Layouts, images and other elements of such user interfaces are not critical to the present invention. The functionality provided by such interfaces is reflected in the claims following this description and it is that functionality which forms a component of the present invention.

Provider's Program Console

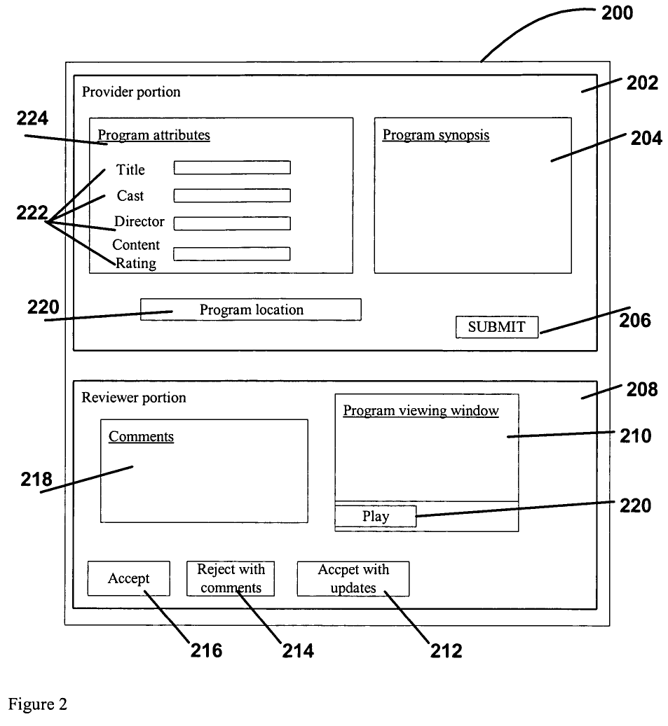

An exemplary embodiment of a content provider's program console by which the content provider may input the metadata describing his/her content is illustrated in the form of a simple web page 200 shown in FIG. 2. The web page is grouped into functional areas—one portion to be filled in by the content provider (202) and the other to be filled in by a reviewer of the submission (208). A control (206) (e.g., a button) is provided for the provider to submit the web form, for example once all the content provider fields have been filled out.

The provider portion of the web form (202) is primarily reserved and configured for the content provider to provide (either as text, selections from drop down menu lists, radio button selections, check box selections, etc.) metadata describing the content selection to be used in preparing the program guide description thereof. Usually, the reviewer will limit his/her interactions with this portion of the web form to a review of the information so provided. However, in some cases the reviewer may be given write access to one or more fields of this portion of the web form in order correct spelling mistakes or make other similar editorial modifications. The metadata to be entered into the web form can be divided into two types—mandatory and optional. Mandatory data may include such things as the title of the multimedia file described by the metadata, while option information may include such things as the date of creation.

Guide Entries

In one embodiment, the provider portion of the web form is designed for the content provider to enter the metadata in the form of program attributes (224) and program synopses (204). In general, a program entry (e.g., as will ultimately be present in the program guide) is made up of two components—one that depends on the program itself and the other that depends on the content provider (e.g., a logo of the content provider). Some entries for the guide may not be entered explicitly using the provider console. For example, program duration (i.e., the running time of the multimedia file) may be automatically calculated and the information added to the program guide.

Program Synopsis

This field of the web form (shown as 204 in FIG. 2) is provided to allow the content provider to submit a descriptive synopsis of the subject matter and story line of the program. It is generally configured as a free text field and may, in some embodiments, have a limit on the number of characters that can be entered. In some cases, help screens or other forms of assistance may be provided to demonstrate to the content provider the type of information which should be entered in this field. Similar help may be available for some or all of the provider console fields.

Program Attributes

Attributes include such things as audience ratings, purchasing information, availability times, etc. Such information may be entered using dialog-boxes, drop-down lists or entry fields, as appropriate. For example, in one embodiment of the invention, the content advisory ratings are organized as a drop-down list and the content provider can choose an appropriate advisory rating for the program therefrom, based on one or more criteria from a conventional ratings systems (e.g., the Motion Pictures Association of America rating system) or a maturity rating scale used by the VOD service operator (e.g., as offered by the assignee of this invention). An example of this field is shown in FIG. 2, which illustrates attribute fields (222) including Title, Cast, Director and Content Rating information.

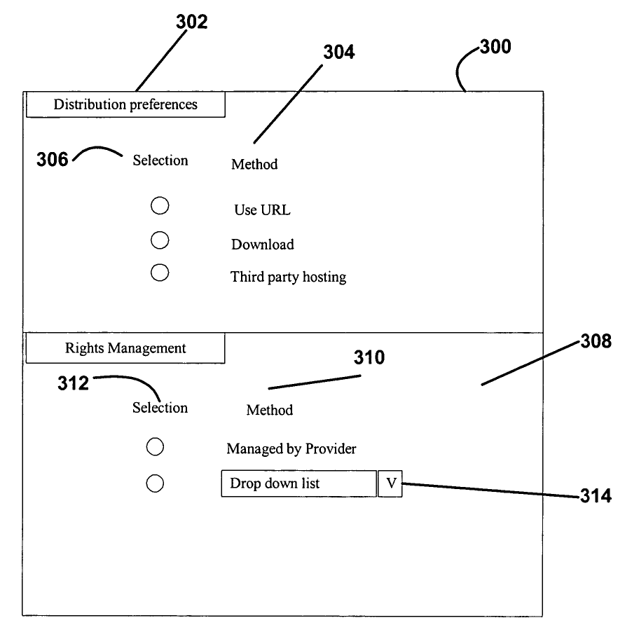

Along with metadata regarding a program, the content provider also needs to submit program location information (220). That is, the content provider needs to alert the VOD service provider (and clients thereof) as to where the content can actually be found for download. In one embodiment of the invention, this field could be configured to accept a user resource locator (URL) for the location of this program on the Internet. In another embodiment, this field may be implemented as a distribution preferences field (302) of the web form 300 shown in FIG. 3. This field gives the provider multiple options for the method used to specify a location for the program in the form of a list (304) and allows the provider to enter his/her selection of the appropriate method (306). Examples of such a method are, without limitation, using a URL, requesting the VOD service provider to host the program on its VOD server, or pointing to a third-party hosting service, etc.

Reviewer Portion

The reviewer's area 208 is designed to allow the reviewer make one of three selections—accept the submission with updates (212), reject the submission with comments (214) and accept the submission without additional changes (216). Of course other embodiments of the present invention may allow for more or fewer options. An area on the web form can be used to fill in comments (218) for the purpose of logging the result and responding to the content provider. The reviewer could optionally view the multimedia file that is being submitted in an area of the web page (210) with some level of control (e.g., play button 220).

Reviewer's Actions

Based on the merits of the submission (or whatever other criteria the VOD service provider adopts), the reviewer either accepts the submission without comments or accepts the submission by making updates to the provider's submission or rejects the submission by adding comments regarding the rejection. When a submission is accepted by the reviewer, it is made available to the program guide database and appears on program guides of some or all users of the VOD service.

Viewing Rights Management

In this area of the web form (308), shown as a part of the web page 300 in FIG. 3, the content provider chooses “business” issues regarding the content such as which entity controls license keys for the content, if any, viewing charges for each viewing level (e.g., individual subscription, group membership, period discounts, promotions, free weekends etc.). In various embodiments, the individual entries of the form can be organized as text input fields, drop down lists, check boxes and so on. FIG. 3 shows one exemplary embodiment where rights management is organized in terms of method (210) to control viewing rights, either by the provider or using a drop down list 314 of a fixed set of options offered by the VOD service provider. The selection is made by choosing from a selection box 312.

Thus, methods and systems for provisioning multimedia content in a VOD service have been described. Although discussed with reference to various illustrated examples, however, the present invention should be limited thereby and instead should only be measured in terms of the claims, which follow.

What is claimed is:

1. A user interface, comprising one or more Web forms configured to permit uploading of metadata describing multimedia content to a program guide distributable to remote set-top appliances configured to permit downloading of the multimedia content from Internet hosts other than that at which the program guide is available.

2. The user interface of claim 1, wherein the user interface includes a provider portion and a reviewer portion, the provider portion configured to permit a provider of the multimedia content to enter a description the multimedia content according to a plurality of categories, and the reviewer portion configured to permit a human reader to review and accept or reject the description provided by the provider.

3. The user interface of claim 2, wherein the reviewer portion includes facilities for the human reviewer to review the multimedia content in addition to the description provided by the provider.

4. The user interface of claim 3, wherein the reviewer portion includes facilities for the human reviewer to edit the description provided by the provider.

5. The user interface of claim 2, wherein the provider portion includes a mandatory field for the provider to indicate the Internet location at which the multimedia content can be downloaded.

6. The user interface of claim 5, wherein the reviewer portion includes facilities for the human reviewer to review the multimedia content in addition to the description provided by the provider.

7. The user interface of claim 6, wherein the reviewer portion provides read only permissions for the human reviewer.

8. The user interface of claim 1, wherein the metadata includes one or more of: content title, cast, director, cost for downloading, description of the multimedia content, and audience rating.

9. A method, comprising distributing metadata describing multimedia content available for download via the Internet to set-top appliances as a program guide which is composed of entries created by multimedia content providers using a Web form configured to accept information concerning the content and formatted according to a common schema for such metadata.

10. The method of claim 9, wherein prior to distributing the metadata at least some of the entries created by the multimedia content providers are reviewed using a read-only user interface.

11. The method of claim 9, wherein the program guide includes information regarding the cost to download the multimedia content described therein.

12. The method of claim 9, wherein the metadata is distributed via an Internet host different than one or more Internet hosts at which the multimedia content is hosted.

13. The method of claim 9, wherein the metadata is distributed via the Internet.

14. The method of claim 13, wherein the metadata is distributed in exchange for a subscription fee.

15. The method of claim 14, wherein the metadata includes some or all of: audience rating for the multimedia content, cost for downloading the multimedia content, title of the multimedia content, cast members appearing in the multimedia content, director of the multimedia content, and an Internet address at which the multimedia content can be located.
